(19) United States
(12) Patent Application Publication
(10) Pub. No.: US 2026/0150100 A1
(43) Pub. Date: May 28, 2026

(54) MESSAGE TRANSMISSION METHOD AND APPARATUS, DEVICE, STORAGE MEDIUM, AND PROGRAM PRODUCT

(71) Applicant: TENCENT TECHNOLOGY (SHENZHEN) COMPANY LIMITED, Shenzhen (CN)

(72) Inventor: Yong YANG, Shenzhen (CN)

(21) Appl. No.: 19/446,593

(22) Filed: Jan. 12, 2026

Related U.S. Application Data
(63) Continuation of application No. PCT/CN2024/113077, filed on Aug. 19, 2024.

(30) Foreign Application Priority Data
Oct. 12, 2023 (CN) 202311326588.5

(51) Int. Cl. H04W 72/1268; H04W 4/44; H04W 72/566

(52) U.S. Cl. CPC H04W 72/1268; H04W 4/44; H04W 72/569

(57) ABSTRACT

A message transmission method performed by an edge computing device includes receiving vehicle communication messages transmitted by a core network user plane device in a core network. Each of the vehicle communication messages is transmitted through a communication network to the core network by a vehicle-mounted terminal mounted at one of platooning vehicles in one or more vehicle platoons. The method further includes performing message scheduling on the vehicle communication messages, and transmitting the vehicle communication messages subjected to the message scheduling to the core network user plane device, to enable the core network user plane device to forward the vehicle communication messages through the communication network. Each of the vehicle communication messages is forwarded to one or more vehicle-mounted terminals other than the vehicle-mounted terminal that transmits the vehicle communication message.

### CROSS-REFERENCE TO RELATED APPLICATIONS

This application is a continuation of International Application No. PCT/CN2024/113077, filed on Aug. 19, 2024, which claims priority to Chinese Patent Application No. 2023113265885, filed with the China National Intellectual Property Administration on Oct. 12, 2023 and entitled “MESSAGE TRANSMISSION METHOD AND APPARATUS, DEVICE, AND STORAGE MEDIUM,” the entire contents of both of which are incorporated by reference.

### FIELD OF THE TECHNOLOGY

Embodiments of this application relate to the field of internet of vehicles technologies, and in particular, to message transmission.

### BACKGROUND OF THE DISCLOSURE

In a network of vehicles, vehicles may implement efficient cooperation through platooning.

In the related art, to implement information exchange between platooning vehicles, a vehicle to X (V2X) device needs to be disposed in each platooning vehicle. The platooning vehicle uses the V2X device to receive vehicle information broadcast by another platooning vehicle, and broadcast vehicle information of the platooning vehicle to another platooning vehicle.

However, there is a spectrum overlap between a main operating frequency band of the V2X device and that of another wireless communication system. As a result, there is large interference in direct communication between the V2X devices, and safety in a driving process of the platooning vehicles is affected.

### SUMMARY

In accordance with the disclosure, there is provided a message transmission method performed by an edge computing device and including receiving vehicle communication messages transmitted by a core network user plane device in a core network. Each of the vehicle communication messages is transmitted through a communication network to the core network by a vehicle-mounted terminal mounted at one of platooning vehicles in one or more vehicle platoons. The method further includes performing message scheduling on the vehicle communication messages, and transmitting the vehicle communication messages subjected to the message scheduling to the core network user plane device, to enable the core network user plane device to forward the vehicle communication messages through the communication network. Each of the vehicle communication messages is forwarded to one or more vehicle-mounted terminals other than the vehicle-mounted terminal that transmits the vehicle communication message.

Also in accordance with the disclosure, there is provided a message transmission method performed by a vehicle-mounted terminal mounted at a platooning vehicle in a vehicle platoon that includes a plurality of platooning vehicles and including generating a vehicle communication message, and transmitting the vehicle communication message to a core network through a communication network, to enable a core network user plane device in the core network to transmit the vehicle communication message to an edge computing device, for the edge computing device to perform message scheduling on the vehicle communication message, and forward the vehicle communication message subjected to the message scheduling to another vehicle-mounted terminal in the vehicle platoon through the core network user plane device.

Also in accordance with the disclosure, there is provided a message transmission method performed by a core network user plane device and including receiving, through a communication network, vehicle communication messages transmitted by vehicle-mounted terminals each mounted at one of platooning vehicles in a vehicle platoon, forwarding the vehicle communication messages to an edge computing device to enable the edge computing device to perform message scheduling on the vehicle communication messages, receiving, from the edge computing device, the vehicle communication messages subjected to the message scheduling, and forwarding the vehicle communication messages subjected to the message scheduling, including, for one vehicle communication message, forwarding the one vehicle communication message to one of more of the vehicle-mounted terminals other than a transmitter vehicle-mounted terminal that transmitted the one vehicle communication message.

### BRIEF DESCRIPTION OF THE DRAWINGS

FIG. 1 is a schematic implementation diagram showing a V2V direct communication process between vehicles.

FIG. 2 is a diagram of a system architecture of a vehicle platooning based driving system according to an exemplary embodiment of this application.

FIG. 3 is a flowchart of a message transmission method according to an exemplary embodiment of this application.

FIG. 4 is a flowchart of a message transmission method according to another exemplary embodiment of this application.

FIG. 5 is a schematic implementation diagram of a message transmission process shown in an exemplary embodiment of this application.

FIG. 6 is a flowchart of a platoon registration process shown in an exemplary embodiment of this application.

FIG. 7 is a schematic implementation diagram of a message transmission process shown in another exemplary embodiment of this application.

FIG. 8 is a structural block diagram of a message transmission apparatus according to an exemplary embodiment of this application.

FIG. 9 is a structural block diagram of a message transmission apparatus according to another exemplary embodiment of this application.

FIG. 10 is a structural block diagram of a message transmission apparatus according to another exemplary embodiment of this application.

FIG. 11 is a schematic structural diagram of a computer device according to an exemplary embodiment of this application.

### DESCRIPTION OF EMBODIMENTS

To make the objectives, the technical solutions, and advantages of this application clearer, the following further describes implementations of this application in detail with reference to the accompanying drawings.

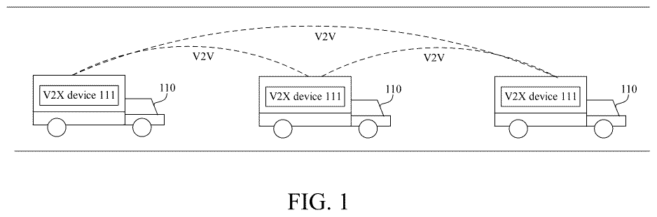

FIG. 1 shows an example of implementing message transmission between vehicles in a vehicle platoon. As shown in FIG. 1, each platooning vehicle 110 is provided with a dedicated V2X device 111. When a platooning vehicle needs to transmit a message to another platooning vehicle, the message is broadcast through the V2X device. The another platooning vehicle receives a broadcast through the V2X device, and implements vehicle to vehicle (V2V) direct communication between the platooning vehicles.

However, because each platooning vehicle is provided with the dedicated V2X device, implementation costs of vehicle platooning based driving are high. In addition, there is large co-channel interference (there is an overlap with frequency bands such as 5G and Wi-Fi) in direct communication between the V2X devices, affecting safety of the vehicle platooning based driving.

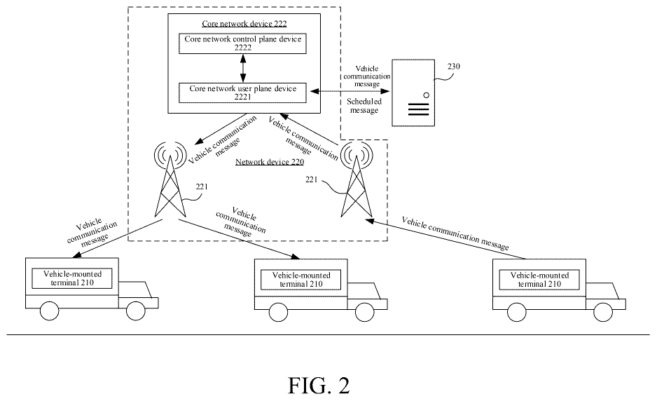

To reduce the implementation costs of the vehicle platooning based driving and improve the safety, an embodiment of this application provides a vehicle platooning based driving system. As shown in FIG. 2, the vehicle platooning based driving system includes a vehicle-mounted terminal 210, a network device 220, and an edge computing device 230.

The vehicle-mounted terminal 210 is a device disposed in a platooning vehicle, and may also be referred to as a vehicle terminal, terminal, user equipment (UE), or the like. The vehicle-mounted terminal 210 may be a wireless terminal, a mobile phone, a tablet computer, an augmented reality (AR) terminal, a virtual reality (VR) terminal, a mixed reality (MR) terminal, user premises equipment, or the like in an autonomous driving system. Different from a V2X device, vehicle-mounted terminals 210 perform indirect communication through a communication network instead of performing V2X direct communication.

In some embodiments, when the platooning vehicle implements autonomous driving, the vehicle-mounted terminal 210 is further connected to a vehicle-end industrial computer on the platooning vehicle. The vehicle-end industrial computer is responsible for environment perception and calculation for autonomous driving, and controls autonomous driving behavior of the vehicle through a controller area network (CAN) bus of the vehicle. In addition, the vehicle-end industrial computer communicates with the vehicle-mounted terminal 210, to implement cooperative driving of the vehicles.

The vehicle-mounted terminal 210 communicates with the network device 220 by using an air interface technology, for example, a Uu interface.

The network device 220 in this application provides functions of access and management of wireless communication. The network device 220 may include an access network device 221 and a core network device 222. The access network device 221 may have various possible implementation forms, such as a base station, an access node, a wireless network controller, a base station controller, a base transceiver station, or a baseband unit, may be a next generation NodeB (gNB) or a transmission point in a fifth generation (5G) mobile communication system, may be one antenna panel or a group of antenna panels (including a plurality of antenna panels) of a base station in a 5G system, or may be a network node forming a gNB or a transmission point.

Functions of the core network device 222 are mainly to provide establishment and management of a user connection, management for a user, and a bearer for a service, and serve as an interface to an external network. The core network device 222 may process and distribute services in an entire network.

The core network device 222 may include a core network user plane device (user plane function, UPF) 2221 and a core network control plane device (control plane function, CPF) 2222. The core network user plane device 2221 is a data plane processing device in a core network, and is responsible for uplink and downlink data transmission. The core network control plane device 2222 implements functions such as session management, mobility management, and policy control.

In this embodiment of this application, the edge computing device 230 is deployed on the core network user plane device 2221 side. The core network user plane device 2221 directly provides a message transmitted by the vehicle-mounted terminal 210 for the edge computing device 230, to reduce a message transmission delay between the vehicle-mounted terminals 210 and improve safety of vehicle platooning based driving.

In some embodiments, the core network user plane device 2221 communicates with the edge computing device 230 through a wired interface, for example, an N6 interface.

In this embodiment of this application, the edge computing device 230 runs a vehicle platooning based driving assistance system. The vehicle platooning based driving assistance system is configured to perform message scheduling on vehicle communication messages in a vehicle platoon. The message scheduling includes controlling a transmission sequence of the vehicle communication messages. For example, a vehicle communication message having higher importance is preferentially transmitted, and a vehicle communication message having lower importance is transmitted later. The importance herein may be reflected by using a message priority.

The communication system shown in this embodiment of this application may be implemented as a dedicated network (for example, a 5G dedicated network), or the communication system may be a public network. The 5G dedicated network is an enterprise or industry wireless dedicated network constructed by using a 3GPP 5G standard. The 3GPP standard defines two 5G dedicated network deployment modes: a standalone non-public network (SNPN) and a public network integrated NPN (PNI-NPN). The PNI-NPN, also referred to as “public network dedicated,” means that an enterprise may deploy a 5G dedicated network in a manner of sharing a radio access network (RAN), sharing a RAN and a core network control plane, or end-to-end sharing of a 5G public network (an end-to-end network slice) with an operator 5G public network. The SNPN, also referred to as an “independent deployment mode,” means that the enterprise independently deploys an entire 5G network from a base station to a core network and a cloud platform, and the 5G network may be isolated from the operator 5G public network.

The 5G dedicated network is applied to industrial internet scenarios such as an intelligent warehouse and intelligent logistics. In most scenarios, a quantity of user terminals is limited, and a set of 5G core network products with a smallest capacity can satisfy requirements of the application scenarios. In this case, there may be only one core network user plane device, and the core network user plane device performs uplink and downlink forwarding of service data of all 5G terminal users.

For example, as shown in FIG. 2, after a platooning vehicle (for example, a head platooning vehicle) located at a head of the vehicle platoon transmits a vehicle communication message to the network device 220 through the vehicle-mounted terminal 210, the core network user plane device 2221 forwards the vehicle communication message to the edge computing device 230. The edge computing device 230 performs message scheduling, and forwards the scheduled vehicle communication message to another platooning vehicle other than the head platooning vehicle in the vehicle platoon through the communication network, to implement transmission of the vehicle communication message in the vehicle platoon.

The vehicle platooning based driving system may be used in a scenario of vehicle platooning based driving in a closed area or an open area. For example, the closed area may be a closed factory area or a closed port, and the open area may be an urban road or an expressway. A specific application scenario is not limited in this embodiment of this application.

The following embodiments are described by using an example in which a message transmission method is applied to the vehicle platooning based driving system shown in FIG. 2.

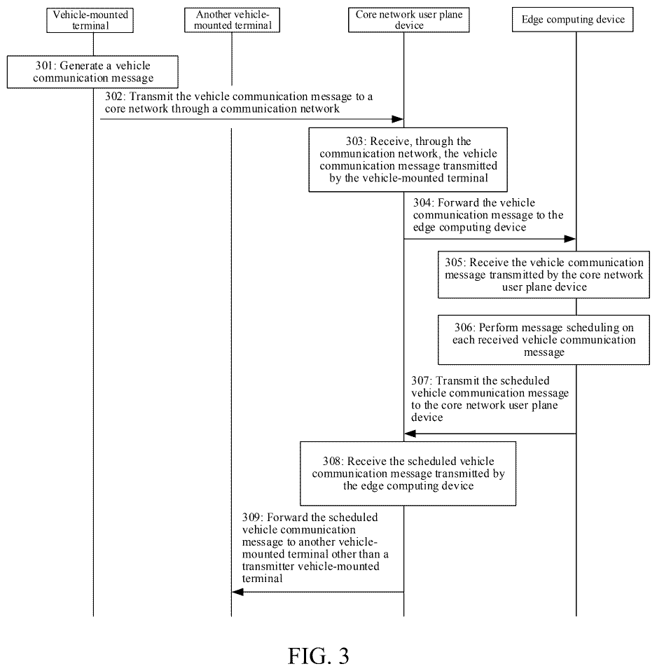

FIG. 3 is a flowchart of a message transmission method according to an exemplary embodiment of this application. This embodiment is described by using an example in which the method is applied to the vehicle platooning based driving system shown in FIG. 2. The method includes the following operations.

Operation 301: A vehicle-mounted terminal generates a vehicle communication message.

In some embodiments, the vehicle communication message may be a message periodically reported by the vehicle-mounted terminal, or may be a message temporarily reported by the vehicle-mounted terminal. For example, the periodically reported vehicle communication message may include vehicle status information such as a real-time vehicle position, a real-time speed, a throttle/switch opening degree, and a remaining oil amount/electric amount of a platooning vehicle corresponding to the vehicle-mounted terminal. The temporarily reported vehicle communication message may include an emergency event, for example, an emergency stop event or an emergency obstacle avoidance event. A generation occasion of the vehicle communication message and specific information content included in the vehicle communication message are not limited in this embodiment of this application.

Any platooning vehicle in the vehicle platoon is provided with the vehicle-mounted terminal, and each vehicle-mounted terminal may transmit a vehicle communication message to another vehicle-mounted terminal.

Operation 302: The vehicle-mounted terminal transmits the vehicle communication message to a core network through a communication network.

The vehicle-mounted terminal in this embodiment of this application is not a V2X device performing V2X direct communication, but a regular communication device (for example, a 5G terminal). Therefore, when needing to transmit the vehicle communication message to another vehicle-mounted terminal, the vehicle-mounted terminal needs to use the communication network. The communication network may be a cellular communication network, for example, a 4G network or a 5G network.

In some embodiments, the vehicle terminal transmits the vehicle communication message to an access network device through an air interface between the vehicle terminal and the access network device, and the access network device transmits the vehicle communication message to the core network.

Operation 303: A core network user plane device receives, through the communication network, the vehicle communication message transmitted by the vehicle-mounted terminal.

The vehicle communication message transmitted by the access network device to the core network first reaches the core network user plane device. To reduce a message transmission delay between vehicle-mounted terminals, in this embodiment of this application, the core network user plane device performs uplink and downlink message transmission between the vehicle-mounted terminals.

Operation 304: The core network user plane device forwards the vehicle communication message to an edge computing device.

In this embodiment of this application, the edge computing device is deployed on the core network user plane device side, and is responsible for message scheduling on the vehicle communication message. Therefore, after receiving the vehicle communication message, the core network user plane device does not forward the message to a core network control plane device, but forwards the message to the edge computing device, so that the edge computing device performs message scheduling.

In some embodiments, to further reduce the message transmission delay, the core network user plane device forwards the vehicle communication message to a nearby edge computing device, for example, a nearest edge computing device.

Operation 305: The edge computing device receives the vehicle communication message transmitted by the core network user plane device.

In some embodiments, the vehicle platooning based driving system may provide a message transmission service for a single vehicle platoon, or may provide the message transmission service for a plurality of vehicle platoons. To be specific, the edge computing device may receive vehicle communication messages transmitted by different platooning vehicles in the same vehicle platoon, or may receive vehicle communication messages transmitted by different platooning vehicles in different vehicle platoons.

Operation 306: The edge computing device performs message scheduling on each received vehicle communication message.

Different from a case in which V2X broadcast data communication is used and priority control for data transmission cannot be performed, in this embodiment, because the vehicle communication messages are transmitted to the edge computing device, the edge computing device may first perform message scheduling on the received messages, to implement priority control for message transmission.

In some embodiments, the edge computing device performs message scheduling based on transmission time of the vehicle communication messages, or performs message scheduling based on transmission time of the vehicle communication messages and message priorities.

When the vehicle platooning based driving system simultaneously provides message transmission services for a plurality of vehicle platoons, the edge computing device needs to distinguish between vehicle platoons to which different vehicle communication messages belong, to perform message scheduling on vehicle communication messages in the same vehicle platoon.

In some embodiments, when there are at least two vehicle communication messages (which may be transmitted by the same vehicle-mounted terminal or different vehicle-mounted terminals) that have not been forwarded, the edge computing device performs message scheduling on the at least two vehicle communication messages, to determine transmission priorities of the messages. A vehicle communication message having a higher message priority is preferentially transmitted to another vehicle-mounted terminal.

Operation 307: The edge computing device transmits the scheduled vehicle communication message to the core network user plane device.

After completing the message scheduling, the edge computing device transmits the vehicle communication message to the core network user plane device based on a sequence of the scheduled vehicle communication messages.

Operation 308: The core network user plane device receives the scheduled vehicle communication message transmitted by the edge computing device.

Operation 309: The core network user plane device forwards the scheduled vehicle communication message to another vehicle-mounted terminal other than a transmitter vehicle-mounted terminal, the transmitter vehicle-mounted terminal being a vehicle-mounted terminal transmitting the vehicle communication message.

Further, the core network user plane device forwards the received vehicle communication message to the another vehicle-mounted terminal other than a transmitter in the vehicle platoon, to implement V2V message transmission between the vehicles.

After receiving the vehicle communication message, the another vehicle-mounted terminal may further parse the vehicle communication message, and transmit data obtained through parsing to a vehicle-end industrial computer, so that the vehicle-end industrial computer performs vehicle driving control based on the data. Details are not described herein in this embodiment of this application.

In conclusion, in embodiments of this application, after the platooning vehicle uses the vehicle-mounted terminal to transmit the vehicle communication message to the core network through the communication network, the core network user plane device forwards the vehicle communication message to the edge computing device, and the edge computing device performs message scheduling on the vehicle communication message in the vehicle platoon, and forwards the vehicle communication message to the vehicle terminal disposed in the another vehicle in the vehicle platoon through the core network user plane device, to implement message broadcasting between the vehicles in the vehicle platoon. Because message transmission does not need to be performed by using dedicated V2X devices, and only a general-purpose vehicle-mounted terminal is needed, implementation costs of vehicle platooning based driving can be reduced. In addition, the vehicle-mounted terminal does not use V2X direct communication, so that a problem of co-channel interference can be avoided, transmission stability of the vehicle communication message is improved, and safety of the vehicle platooning based driving is further improved.

To avoid a case in which another vehicle-mounted terminal does not correctly receive the forwarded vehicle communication message due to factors such as network fluctuation, in some embodiments, after receiving the forwarded vehicle communication message, a receiver vehicle-mounted terminal transmits a receiving response to the edge computing device through the communication network based on a receiving status. If the receiving response indicates that the message is correctly received, the edge computing device does not need to re-forward the message. If the receiving response indicates that the message is not correctly received or the receiving response is not received within a duration threshold, the edge computing device retransmits the message.

During actual application, vehicle communication messages transmitted by different platooning vehicles in the vehicle platoon and vehicle communication messages of different types have different degrees of impact on the safety of the vehicle platooning based driving. If sequential message scheduling is performed based only on the message transmission time, a driving abnormality may occur because an important message is not forwarded in time. To improve the safety of the vehicle platooning based driving, the edge computing device performs message scheduling based on the message priorities of the vehicle communication messages. Descriptions are provided below by using an exemplary embodiment.

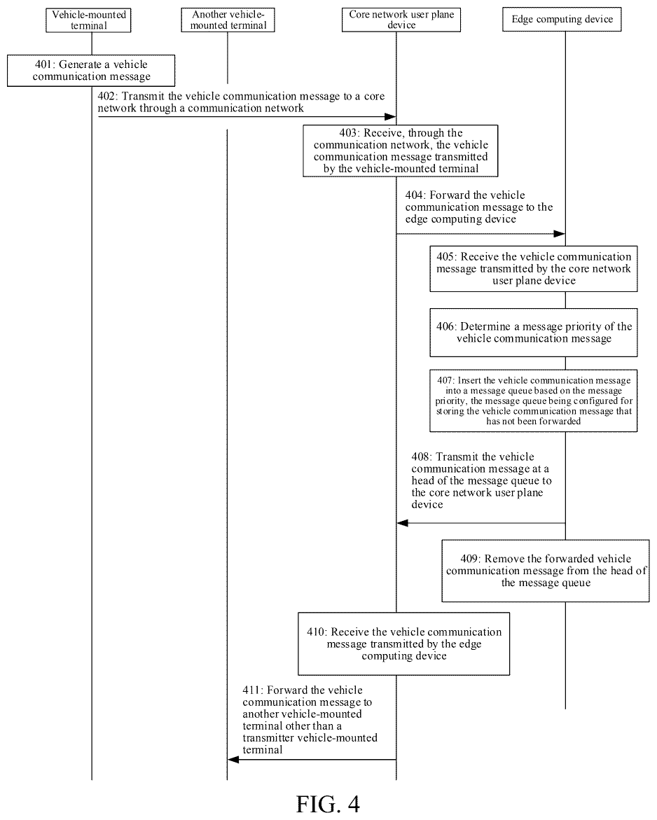

FIG. 4 is a flowchart of a message transmission method according to another exemplary embodiment of this application. This embodiment is described by using an example in which the method is applied to the vehicle platooning based driving system shown in FIG. 2. The method includes the following operations.

Operation 401: A vehicle-mounted terminal generates a vehicle communication message.

In a possible implementation, the vehicle communication message carries a priority identifier indicating a message priority. Correspondingly, an edge computing device may subsequently directly determine the message priority of the vehicle communication message based on the priority identifier.

In some embodiments, the vehicle-mounted terminal determines a message priority based on a message parameter, and generates, based on the message priority, the vehicle communication message including a priority identifier. Different message priorities correspond to different priority identifiers.

For example, when it is determined that message priorities of vehicle communication messages are divided into three levels: a first message priority, a second message priority, and a third message priority, corresponding priority identifiers are respectively 1, 2, and 3.

Levels of the message priorities and a representation manner of the priority identifiers may alternatively use other designs. This is not limited in this embodiment of this application.

In some embodiments, the message parameter includes a transmitter identifier and an event type.

The transmitter identifier uniquely identifies a vehicle in a vehicle platoon, and may be a terminal identifier of the vehicle-mounted terminal, or may be a vehicle position identifier of a platooning vehicle in which the vehicle-mounted terminal is located. For example, a transmitter identifier “1” indicates that the vehicle-mounted terminal is located in a head platooning vehicle, a transmitter identifier “2” indicates that the vehicle-mounted terminal is located in a second platooning vehicle in the platoon, and so on. A specific form of the transmitter identifier is not limited in this embodiment of this application.

The event type represents a type of a communication event corresponding to the message, and emergency or importance levels of different event types are different (in other words, classification of types is performed based on the emergency or importance levels of the events). In some embodiments, the event type may include a regular event and a special event, and an emergency or importance level of the regular event is lower than that of the special event.

In some embodiments, the regular event may be an event periodically reported by the vehicle-mounted terminal, for example, a periodically reported vehicle status. The special event may be an event temporarily reported by the vehicle-mounted terminal, for example, a temporarily reported emergency event. A specific classification manner of the event type is not limited in this embodiment of this application.

In a possible implementation, that the vehicle-mounted terminal determines the message priority based on the message parameter may include the following several cases:

1. It is determined that the vehicle communication message has the first message priority, when the transmitter identifier represents that the vehicle communication message is transmitted by the head platooning vehicle in the vehicle platoon and the event type is the special event.

In some embodiments, the vehicle-mounted terminal may determine, based on the transmitter identifier, whether a platooning vehicle to which the vehicle communication message belongs is the head platooning vehicle. When recognizing that the platooning vehicle is the head platooning vehicle, the vehicle-mounted terminal further recognizes whether the event type is the special event.

Because the head platooning vehicle is usually a command center of the entire vehicle platoon, a vehicle communication message transmitted by the head platooning vehicle has a higher priority. In addition, because a vehicle communication message transmitted when a special event is triggered usually needs to be forwarded to another vehicle-mounted terminal in time, to enable another platooning vehicle to take a corresponding measure for the special event in time, a vehicle communication message corresponding to the special event usually has a higher priority. In conclusion, when the vehicle communication message is transmitted by the head platooning vehicle, and the event type is the special event, the vehicle-mounted terminal determines that the vehicle communication message has the first message priority, that is, a highest message priority, to ensure driving safety of the vehicle platoon in a special case.

In some embodiments, the vehicle-mounted terminal may further subdivide the first message priority to into sub-priorities based on a subtype of the special event. This is not limited in this embodiment of this application.

2. It is determined that the vehicle communication message has the second message priority, when the transmitter identifier represents that the vehicle communication message is transmitted by the head platooning vehicle in the vehicle platoon and the event type is the regular event.

The regular event has less impact on driving safety than the special event. Therefore, when recognizing that the vehicle communication message is transmitted by the head platooning vehicle, and the event type is the regular event, the vehicle-mounted terminal determines that the vehicle communication message has the second message priority. The second message priority is lower than the first message priority.

In some embodiments, the vehicle-mounted terminal may further subdivide the second message priority into sub-priorities based on a subtype of the regular event. This is not limited in this embodiment of this application.

3. It is determined that the vehicle communication message has the third message priority, when the transmitter identifier represents that the vehicle communication message is transmitted by a following platooning vehicle in the vehicle platoon, the following platooning vehicle being a vehicle other than the head platooning vehicle in the vehicle platoon.

A vehicle communication message transmitted by a non-head platooning vehicle (that is, the following platooning vehicle) in the vehicle platoon usually mainly reports a status, and has low impact on driving safety of the vehicle platoon. Therefore, when recognizing that the vehicle communication message is transmitted by the following platooning vehicle, the vehicle-mounted terminal determines that the vehicle communication message has the third message priority. The third message priority is lower than the second message priority.

Because a platooning vehicle that is closer to the front in the vehicle platoon affects more following platooning vehicles, the platooning vehicle that is closer to the front has greater impact on the driving safety. To further improve the driving safety, in some embodiments, the vehicle-mounted terminal needs to perform more fine-grained priority division for the vehicle communication message transmitted by the following platooning vehicle.

In a possible implementation, when the transmitter identifier represents that the vehicle communication message is transmitted by the following platooning vehicle in the vehicle platoon, the vehicle-mounted terminal determines a message sub-priority of the vehicle communication message from the third message priority based on a platooning position of the following platooning vehicle in the vehicle platoon. The message sub-priority is positively correlated with the platooning position.

A platooning position may indicate a position number of a position of a vehicle in the platoon. For example, a platooning position 1 indicates that the vehicle is located at a head of the platoon, and a platooning position 2 indicates that the vehicle is located behind the head platooning vehicle.

In a possible implementation, the vehicle-mounted terminal may determine the platooning position of the current following platooning vehicle in the vehicle platoon based on the transmitter identifier.

For a following platooning vehicle whose platooning position is closer to the front, because there are more vehicles behind the following platooning vehicle, the vehicle-mounted terminal allocates a higher message sub-priority to a vehicle communication message transmitted by the following platooning vehicle.

In a schematic example, when the vehicle platoon includes five platooning vehicles, a vehicle communication message transmitted by a following platooning vehicle at a platooning position 2 has a message priority 3.1, a vehicle communication message transmitted by a following platooning vehicle at a platooning position 3 has a message priority 3.2, a vehicle communication message transmitted by a following platooning vehicle at a platooning position 4 has a message priority 3.3, and a vehicle communication message transmitted by a following platooning vehicle at a platooning position 5 has a message priority 3.4. The message priority 3.1>the message priority 3.2>the message priority 3.3>the message priority 3.4.

In addition to a case in which the vehicle-mounted terminal determines the message priority, in another possible implementation, the vehicle communication message carries a message parameter and does not carry a priority identifier. Correspondingly, the edge computing device may subsequently determine the message priority of the vehicle communication message based on the message parameter. Logic for determining the message priority by the edge computing device is consistent with logic for determining the message priority by the vehicle-mounted terminal.

In some embodiments, the vehicle-mounted terminal generates the vehicle communication message carrying the transmitter identifier and the event type.

Operation 402: The vehicle-mounted terminal transmits the vehicle communication message to a core network through a communication network.

Operation 403: A core network user plane device receives, through the communication network, the vehicle communication message transmitted by the vehicle-mounted terminal.

Operation 404: The core network user plane device forwards the vehicle communication message to the edge computing device.

Operation 405: The edge computing device receives the vehicle communication message transmitted by the core network user plane device.

For specific implementations of operations 402 to 405, refer to operations 302 to 305. Details are not described herein again in this embodiment.

Operation 406: The edge computing device determines the message priority of the vehicle communication message.

In a possible implementation, when an indication of the message priority is displayed in the vehicle communication message by using the priority identifier, the edge computing device may directly extract the priority identifier from the vehicle communication message, and determine the message priority based on the priority identifier.

In another possible implementation, when the vehicle communication message does not carry a priority identifier but only carries an original message parameter, the edge computing device obtains the message parameter from the vehicle communication message, to determine the message priority of the vehicle communication message based on the message parameter.

A plurality of manners of determining the message priority are provided, so that the message priority is flexibly and diversely set, and can adapt to more message transmission scenarios.

In some embodiments, the edge computing device determines that the vehicle communication message has the first message priority, when the transmitter identifier represents that the vehicle communication message is transmitted by the head platooning vehicle in the vehicle platoon and the event type is the special event.

The edge computing device determines that the vehicle communication message has the second message priority, when the transmitter identifier represents that the vehicle communication message is transmitted by the head platooning vehicle in the vehicle platoon and the event type is the regular event.

The edge computing device determines that the vehicle communication message has the third message priority, when the transmitter identifier represents that the vehicle communication message is transmitted by the following platooning vehicle in the vehicle platoon, the following platooning vehicle being a vehicle other than the head platooning vehicle in the vehicle platoon.

Further, when the transmitter identifier represents that the vehicle communication message is transmitted by the following platooning vehicle in the vehicle platoon, the edge computing device determines the platooning position of the following platooning vehicle in the vehicle platoon, and determines the message sub-priority of the vehicle communication message from the third message priority based on the platooning position. The message sub-priority is positively correlated with the platooning position.

For a specific manner of determining the message priority by the edge computing device, refer to the manner of determining the message priority by the vehicle-mounted terminal. Details are not described herein again in this embodiment.

Operation 407: The edge computing device inserts the vehicle communication message into a message queue based on the message priority, the message queue being configured for storing the vehicle communication message that has not been forwarded.

To implement sequential forwarding of vehicle communication messages based on emergency or importance levels, in a possible implementation, the edge computing device maintains the message queue, and the message queue stores vehicle communication messages that are received but have not been forwarded.

When simultaneously scheduling messages in a plurality of vehicle platoons, the edge computing device maintains a message queue for each vehicle platoon, and inserts, based on the message priority, the vehicle communication message into a message queue corresponding to a vehicle platoon to which the vehicle sending the vehicle communication message belongs.

For a manner of inserting the vehicle communication message into the message queue, in some embodiments, a higher message priority of a vehicle communication message indicates a shorter distance between the vehicle communication message and a head of the message queue, that is, a vehicle communication message with a higher message priority is closer to the head of the message queue.

In some embodiments, when there are at least two vehicle communication messages that have the same message priority, the edge computing device inserts the vehicle communication messages into the message queue in a sequence of transmission time of the at least two vehicle communication messages.

In a schematic example, the message queue maintained by the edge computing device is shown in Table 1.

TABLE 1

| Queue sequence | | | |
|---|---|---|---|
| number | 1 | 2 | 3 |
| Vehicle | Message A | Message B | Message C |
| communication | | | |
| message | | | |
| Message priority | First message | Second message | Third message |
| | priority | priority | priority |
| Transmission time | 10:10:30 | 10:10:29 | 10:10:28 |

When a message D that is of the special event and that is transmitted by the head platooning vehicle is received at 10:10:31, because a message priority of the vehicle communication message is the first message priority, and transmission time of the message D is after that of the message A, after the message D is added to the message queue, the message queue is shown in Table 2.

TABLE 2

| Queue sequence | | | | |
|---|---|---|---|---|
| number | 1 | 2 | 3 | 4 |
| Vehicle communication | Message A | Message D | Message B | Message C |
| message | | | | |
| Message priority | First message | First message | Second message | Third message |
| | priority | priority | priority | priority |
| Transmission time | 10:10:30 | 10:10:31 | 10:10:29 | 10:10:28 |

Operation 408: The edge computing device transmits the vehicle communication message at the head of the message queue to the core network user plane device, the vehicle communication message at the head of the message queue having a highest message priority in the message queue.

Each time the edge computing device performs message forwarding, the edge computing device obtains a vehicle communication message from the head of the message queue, that is, preferentially transmits the vehicle communication message having the highest message priority in the message queue to the core network user plane device, and the core network user plane device forwards the vehicle communication message to another platooning vehicle in the vehicle platoon.

With reference to the message queue shown in Table 2, the edge computing device transmits the message A at the head of the message queue to the core network user plane device.

Operation 409: The edge computing device removes the forwarded vehicle communication message from the head of the message queue.

To avoid a case in which the same vehicle communication message is repeatedly forwarded, each time message transmission is completed, the edge computing device needs to remove the forwarded vehicle communication message from the head of the message queue. With reference to the message queue shown in Table 2, after the edge computing device transmits the message A to the core network user plane device, an updated message queue is shown in Table 3.

TABLE 3

| Queue sequence | | | |
|---|---|---|---|
| number | 1 | 2 | 3 |
| Vehicle | Message D | Message B | Message C |
| communication | | | |
| message | | | |
| Message priority | First message | Second message | Third message |
| | priority | priority | priority |
| Transmission time | 10:10:31 | 10:10:29 | 10:10:28 |

Operation 410: The core network user plane device receives the vehicle communication message transmitted by the edge computing device.

Operation 411: The core network user plane device forwards the vehicle communication message to another vehicle-mounted terminal other than a transmitter vehicle-mounted terminal, the transmitter vehicle-mounted terminal being a vehicle-mounted terminal transmitting the vehicle communication message.

For specific implementations of operations 410 and 411, refer to operations 308 and 309. Details are not described herein again in this embodiment.

In this embodiment, the message priority of the vehicle communication message is determined based on the message parameter, and the received vehicle communication message is inserted into the message queue based on the message priority. The edge computing device obtains the vehicle communication message from the head of the message queue and forwards the message, to ensure that a vehicle communication message with a higher message priority can be preferentially forwarded to another platooning vehicle. This helps improve safety in a driving process of the vehicle platoon.

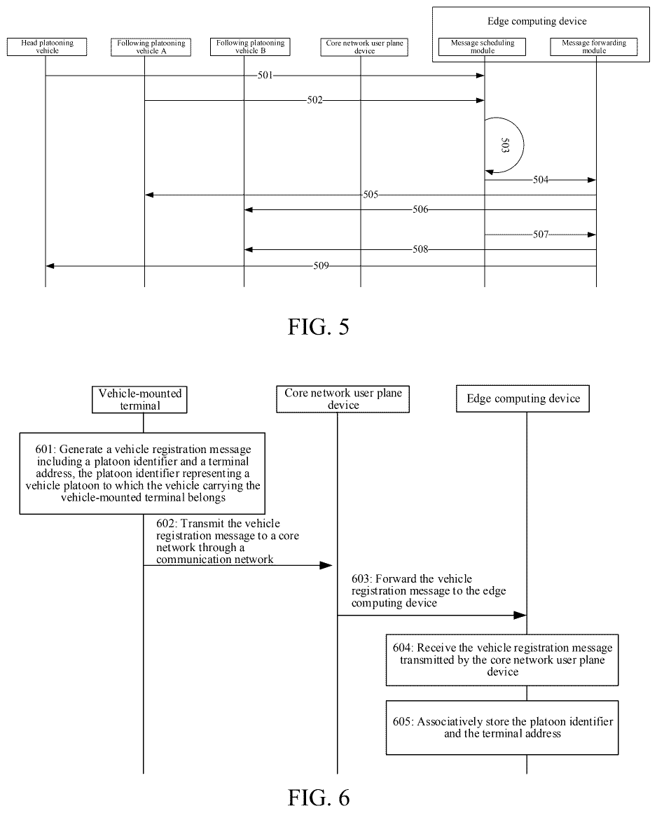

In a schematic scenario, a vehicle platoon includes a head platooning vehicle and following platooning vehicles A and B, and a message scheduling module and a message forwarding module is disposed in an edge computing device. A message transmission process in the vehicle platoon is shown in FIG. 5.

Operation 501: The head platooning vehicle transmits a vehicle platooning message to the edge computing device through a core network user plane device.

Operation 502: The following platooning vehicle A transmits a vehicle platooning message to the edge computing device through the core network user plane device.

Operation 503: The message scheduling module of the edge computing device obtains priority identifiers from the vehicle platooning messages, and sorts the messages based on message priorities indicated by the priority identifiers.

Because the priority of the message transmitted by the head platooning vehicle is higher than the priority of the message transmitted by the following platooning vehicle, in a message queue, the vehicle communication message transmitted by the head platooning vehicle is located before the vehicle communication message transmitted by the following platooning vehicle.

Operation 504: The message scheduling module of the edge computing device instructs the message forwarding module to preferentially forward the vehicle platooning message transmitted by the head platooning vehicle.

Operation 505: The message forwarding module of the edge computing device forwards the vehicle platooning message to the following platooning vehicle A through the core network user plane device.

Operation 506: The message forwarding module of the edge computing device forwards the vehicle platooning message to the following platooning vehicle B through the core network user plane device.

Operation 507: The message scheduling module of the edge computing device instructs the message forwarding module to forward the vehicle platooning message transmitted by the following platooning vehicle.

Operation 508: The message forwarding module of the edge computing device forwards the vehicle platooning message to the following platooning vehicle B through the core network user plane device.

Operation 509: The message forwarding module of the edge computing device forwards the vehicle platooning message to the head platooning vehicle through the core network user plane device.

In a process of performing message forwarding by the edge computing device, to determine a vehicle and a platooning vehicle in the vehicle platoon to which the message is forwarded, to ensure accuracy of the message forwarding, in a possible implementation, a vehicle-mounted terminal disposed in each platooning vehicle needs to perform vehicle registration at the edge computing device in advance, so that the edge computing device subsequently performs message forwarding based on vehicle registration information.

As shown in FIG. 6, a vehicle registration process before message transmission includes the following operations.

Operation 601: A vehicle-mounted terminal generates a vehicle registration message including a platoon identifier and a terminal address, the platoon identifier representing a vehicle platoon to which the vehicle carrying the vehicle-mounted terminal belongs.

In a possible implementation, before platooning based driving, a vehicle-mounted terminal disposed in each platooning vehicle needs to perform vehicle registration at an edge computing device. The vehicle registration process is transmitting the vehicle registration message including the platoon identifier and the terminal address. The platoon identifier is unique, and may be set by a user, or may be allocated by the edge computing device from a platoon identifier pool.

In some embodiments, the terminal address is an internet protocol (IP) address of the vehicle-mounted terminal. Correspondingly, message forwarding is subsequently performed based on the IP address.

In another possible implementation, the vehicle registration message may further include a transmitter identifier, an identifier indicating whether the vehicle is a head vehicle, and the like. This is not limited in this embodiment.

Operation 602: The vehicle-mounted terminal transmits the vehicle registration message to a core network through a communication network.

Operation 603: A core network user plane device forwards the vehicle registration message to the edge computing device.

After receiving the vehicle registration message, the core network user plane device forwards the vehicle registration message to the edge computing device, to complete vehicle registration.

Operation 604: The edge computing device receives the vehicle registration message transmitted by the core network user plane device.

Operation 605: The edge computing device associatively stores the platoon identifier and the terminal address.

For received vehicle registration messages transmitted by vehicle-mounted terminals in the same vehicle platoon, because all the vehicle registration messages include the same platoon identifier, the edge computing device associatively stores the platoon identifiers and the terminal addresses.

In some embodiments, after completing associated storage, the edge computing device may transmit a registration complete response to the vehicle-mounted terminals through the core network user plane device, to notify the vehicle-mounted terminals that the vehicle registration is completed. In a schematic example, correspondences between the platoon identifiers and the terminal addresses existing in the edge computing device are shown in Table

TABLE 4

| Platoon identifier | Terminal address |
|---|---|
| Platoon 001 | IP 1, IP 2, IP 3, and IP 4 |
| Platoon 002 | IP 1, IP 5, IP 6, and IP 7 |
| Platoon 003 | IP 8, IP 9, and IP 10 |

In some embodiments, in addition to performing vehicle registration, the vehicle-mounted terminal may further perform vehicle deregistration. In some embodiments, the vehicle-mounted terminal generates a vehicle deregistration message including a platoon identifier and a terminal address, and transmits the vehicle deregistration message to the core network and the edge computing device through the communication network. After receiving the vehicle deregistration message, the edge computing device removes a to-be-deregistered terminal address from terminal addresses associated with the platoon identifier.

In some embodiments, the vehicle-mounted terminal may further perform platoon deregistration. In some embodiments, the vehicle-mounted terminal generates a platoon deregistration message including a platoon identifier, and transmits the platoon deregistration message to the core network and the edge computing device through the communication network. After receiving the platoon deregistration message, the edge computing device deletes the platoon identifier and an associated terminal address.

The following operations may be included when the scheduled vehicle communication message is subsequently transmitted to the core network user plane device.

1. Obtain a platoon identifier from the vehicle communication message, the platoon identifier representing a vehicle platoon to which the vehicle sending the message belongs.

Because the same vehicle may belong to different vehicle platoons, to ensure message forwarding accuracy, the vehicle communication message transmitted by the vehicle-mounted terminal includes the platoon identifier of the vehicle platoon to which the vehicle currently belongs. Correspondingly, the edge computing device obtains the platoon identifier from the vehicle communication message, to determine to a platooning vehicle in a specific vehicle platoon to which the message is forwarded.

With reference to data shown in Table 4, the edge computing device obtains the platoon identifier “platoon 001” from the vehicle communication message.

2. Determine a receiver address based on a transmitter address of a transmitter vehicle-mounted terminal corresponding to the vehicle communication message, and a terminal address that is of each vehicle-mounted terminal and that corresponds to the platoon identifier.

Because the vehicle communication message only needs to be forwarded to another vehicle-mounted terminal other than the transmitter, the edge computing device first obtains terminal addresses of the vehicle-mounted terminals in the vehicle platoon based on the platoon identifier, and determines an address other than the transmitter address in the terminal addresses as the receiver address.

With reference to the data shown in Table 4, when the transmitter address of the transmitter vehicle-mounted terminal is IP 1, the edge computing device determines that receiver addresses are IP 2, IP 3, and IP 4.

3. Transmit the vehicle communication message including the receiver address to the core network user plane device.

Further, the edge computing device transmits the vehicle communication message including the receiver address to the core network user plane device, and the core network user plane device forwards, based on the receiver address, the vehicle communication message to the corresponding receiver vehicle-mounted terminal through the communication network.

In the foregoing embodiments, the core network user plane device is mainly responsible for message transmission, and actual scheduling and control is performed by the edge computing device. To further reduce a transmission delay, the edge computing device may configure a message scheduling policy in the core network user plane device, and the core network user plane device performs message scheduling and forwarding based on the configuration.

In a possible implementation, the edge computing device transmits a message scheduling policy corresponding to the vehicle platoon to the core network user plane device, the message scheduling policy indicating a message scheduling manner of the vehicle communication message in the vehicle platoon.

In some embodiments, different vehicle platoons may correspond to the same message scheduling policy, or may correspond to different message scheduling policies.

In some embodiments, to avoid excessively high processing pressure of the core network user plane device, the edge computing device may configure a message scheduling policy of a part of the vehicle platoon on the core network user plane device side. Correspondingly, when receiving the vehicle communication message, the core network user plane device determines whether message scheduling on the vehicle communication message is supported.

When message scheduling on the vehicle platoon is not supported, the core network user plane device forwards the vehicle communication message to the edge computing device, and the edge computing device performs message scheduling.

When message scheduling on the vehicle platoon is supported, the core network user plane device performs message scheduling on each received vehicle communication message, and forwards the scheduled vehicle communication message to another vehicle-mounted terminal other than the transmitter vehicle-mounted terminal.

For a manner of performing message scheduling by the core network user plane device, refer to the edge computing device. Details are not described herein again in this embodiment.

In some embodiments, the core network user plane device determines, by detecting whether the message scheduling policy corresponding to the vehicle platoon is stored, whether message scheduling on the vehicle platoon is supported. When the message scheduling policy corresponding to the vehicle platoon is stored, it is determined that message scheduling on the vehicle platoon is supported. When the message scheduling policy corresponding to the vehicle platoon is not stored, it is determined that message scheduling on the vehicle platoon is not supported.

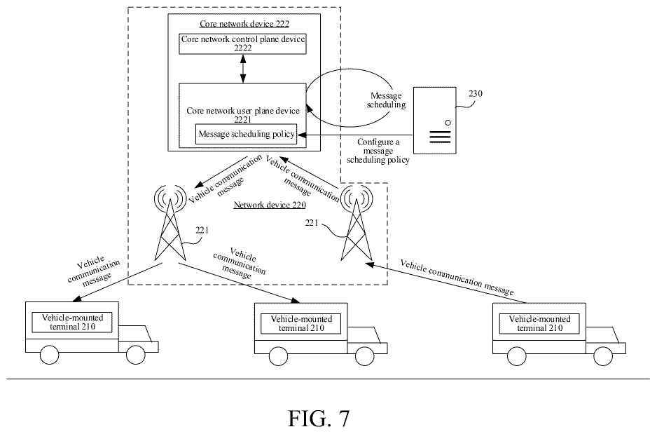

As shown in FIG. 7, an edge computing device 230 pre-configures a message scheduling policy of a vehicle platoon in a core network user plane device 2221. After a head platooning vehicle subsequently transmits a vehicle communication message to a network device 220 through a vehicle-mounted terminal 210, because message scheduling on the vehicle platoon is supported, the core network user plane device 2221 does not need to forward the vehicle communication message to the edge computing device 230. Instead, the core network user plane device 2221 directly performs message scheduling based on the configured message scheduling policy, and forwards the scheduled vehicle communication message to another platooning vehicle other than a head platooning vehicle through a communication network, to implement transmission of the vehicle message in the vehicle platoon without performing data communication between the core network user plane device 2221 and the edge computing device 230, to further reduce a message transmission delay.

In this embodiment, after the edge computing device configures the message scheduling policy in the core network user plane device, the core network user plane device performs message scheduling and forwarding based on the configuration, so that a transmission delay caused by performing data communication between the core network user plane device and the edge computing device is avoided, to further reduce the message transmission delay, and improve driving safety of the vehicle platoon.

In the foregoing embodiments, operations performed by the vehicle-mounted terminal may be independently implemented as a message transmission method on the vehicle-mounted terminal side, operations performed by the core network user plane device may be independently implemented as a message transmission method on the core network user plane device side, and operations performed by the edge computing device may be independently implemented as a message transmission method on the edge computing device side. Details are not described herein again in this embodiment.

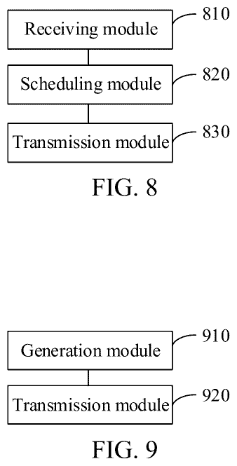

FIG. 8 is a structural block diagram of a message transmission apparatus according to an exemplary embodiment of this application. The apparatus includes:

a receiving module 810, configured to receive a vehicle communication message transmitted by a core network user plane device in a core network, the vehicle communication message being transmitted to the core network by a vehicle-mounted terminal through a communication network, and each platooning vehicle in a vehicle platoon being provided with the vehicle-mounted terminal;

a scheduling module 820, configured to perform message scheduling on each received vehicle communication message; and

a transmission module 830, configured to transmit the scheduled vehicle communication message to the core network user plane device, to enable the core network user plane device to forward the vehicle communication message to another vehicle-mounted terminal other than a transmitter vehicle-mounted terminal through the communication network, the transmitter vehicle-mounted terminal being a vehicle-mounted terminal transmitting the vehicle communication message.

In some embodiments, the scheduling module 820 is configured to:
determine a message priority of the vehicle communication message; and
insert the vehicle communication message into a message queue based on the message priority, the message queue being configured for storing the vehicle communication message that has not been forwarded;
the transmission module 830 is configured to:
transmit the vehicle communication message at a head of the message queue to the core network user plane device, the vehicle communication message at the head of the message queue having a highest message priority in the message queue; and
the scheduling module 820 is further configured to:
remove the forwarded vehicle communication message from the head of the message queue.

In some embodiments, the scheduling module 820 is configured to:
determine the message priority based on a priority identifier included in the vehicle communication message, the priority identifier being determined by the vehicle-mounted terminal and added to the vehicle communication message; or
obtain a message parameter from the vehicle communication message, and determine the message priority of the vehicle communication message based on the message parameter.

In some embodiments, the message parameter includes a transmitter identifier and an event type; and the scheduling module 820 is configured to:
determine that the vehicle communication message has a first message priority,
when the transmitter identifier represents that the vehicle communication message is transmitted by a head platooning vehicle in the vehicle platoon and the event type is a special event;
determine that the vehicle communication message has a second message priority, when the transmitter identifier represents that the vehicle communication message is transmitted by a head platooning vehicle in the vehicle platoon and the event type is a regular event; or
determine that the vehicle communication message has a third message priority, when the transmitter identifier represents that the vehicle communication message is transmitted by a following platooning vehicle in the vehicle platoon, the following platooning vehicle being a vehicle other than a head platooning vehicle in the vehicle platoon,
the first message priority being higher than the second message priority, and the second message priority being higher than the third message priority.

In some embodiments, the scheduling module 820 is further configured to:
determine a platooning position of the following platooning vehicle in the vehicle platoon when the transmitter identifier represents that the vehicle communication message is transmitted by the following platooning vehicle in the vehicle platoon; and
determine a message sub-priority of the vehicle communication message from the third message priority based on the platooning position, a closer platooning position to the head platooning vehicle indicating a higher corresponding message sub-priority.

In some embodiments, the transmission module 830 is configured to:
obtain a platoon identifier from the vehicle communication message, the platoon identifier representing a vehicle platoon to which the vehicle belongs;
determine a receiver address based on a transmitter address of the transmitter vehicle-mounted terminal corresponding to the vehicle communication message, and a terminal address that is of each vehicle-mounted terminal and that corresponds to the platoon identifier; and
transmit the vehicle communication message including the receiver address to the core network user plane device.

In some embodiments, the receiving module 810 is further configured to:
receive a vehicle registration message transmitted by the core network user plane device, the vehicle registration message being transmitted by the vehicle-mounted terminal to the core network through the communication network, and the vehicle registration message including the platoon identifier and the terminal address of the vehicle-mounted terminal; and
a storage module is configured to associatively store the platoon identifier and the terminal address.

FIG. 9 is a structural block diagram of a message transmission apparatus according to another exemplary embodiment of this application. The apparatus includes:
a generation module 910, configured to generate a vehicle communication message; and
a transmission module 920, configured to transmit the vehicle communication message to a core network through a communication network, to enable a core network user plane device in the core network to transmit the vehicle communication message to an edge computing device, the edge computing device performing message scheduling on each received vehicle communication message, and forwarding the scheduled vehicle communication message to another vehicle-mounted terminal other than a transmitter vehicle-mounted terminal through the core network user plane device, the transmitter vehicle-mounted terminal being a vehicle-mounted terminal transmitting the vehicle communication message, and the transmitter vehicle-mounted terminal being disposed in a platooning vehicle in a vehicle platoon.

In some embodiments, the generation module 910 is configured to:
determine a message priority based on a message parameter, and generate, based on the message priority, the vehicle communication message including a priority identifier; or
generate the vehicle communication message including a message parameter, the message parameter being configured for determining the message priority of the vehicle communication message.

In some embodiments, the message parameter includes a transmitter identifier and an event type; and the generation module 910 is configured to:
determine that the vehicle communication message has a first message priority,
when the transmitter identifier represents that the vehicle terminal is disposed in a head platooning vehicle in the vehicle platoon and the event type is a special event;
determine that the vehicle communication message has a second message priority, when the transmitter identifier represents that the vehicle terminal is disposed in a head platooning vehicle in the vehicle platoon and the event type is a regular event; or
determine that the vehicle communication message has a third message priority, when the transmitter identifier represents that the vehicle terminal is disposed in a following platooning vehicle in the vehicle platoon, the following platooning vehicle being a vehicle other than a head platooning vehicle in the vehicle platoon,
the first message priority being higher than the second message priority, and the second message priority being higher than the third message priority.

In some embodiments, the generation module 910 is configured to:
determine a message sub-priority of the vehicle communication message from the third message priority based on a platooning position of the following platooning vehicle in the vehicle platoon when the transmitter identifier represents that the vehicle terminal is disposed in the following platooning vehicle in the vehicle platoon, a closer platooning position to the head platooning vehicle indicating a higher corresponding message sub-priority.

In some embodiments, the generation module 910 is further configured to:
generate a vehicle registration message including a platoon identifier and a terminal address, the platoon identifier representing a vehicle platoon to which the vehicle belongs; and
the transmission module 920 is further configured to transmit the vehicle registration message to the core network through the communication network, to enable the core network user plane device to transmit the vehicle registration message to the edge computing device, the edge computing device associatively storing the platoon identifier and the terminal address, and determining a receiver address based on a transmitter address of the transmitter vehicle-mounted terminal corresponding to the vehicle communication message and a terminal address that is of each vehicle-mounted terminal and that corresponds to the platoon identifier when forwarding the vehicle communication message.

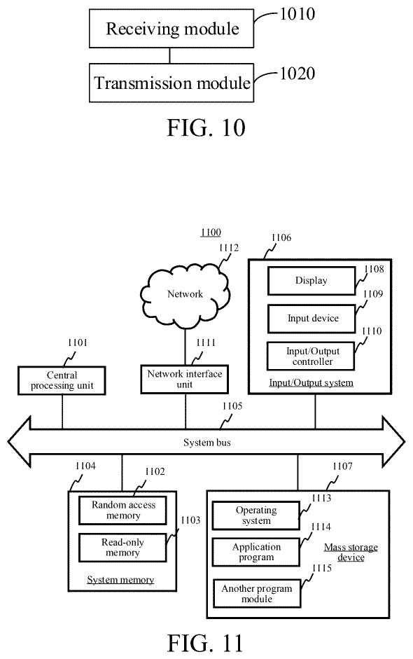

FIG. 10 is a structural block diagram of a message transmission apparatus according to another exemplary embodiment of this application. The apparatus includes:
a receiving module 1010, configured to receive, through a communication network, a vehicle communication message transmitted by a vehicle-mounted terminal, each platooning vehicle in a vehicle platoon being provided with the vehicle-mounted terminal; and
a transmission module 1020, configured to forward the vehicle communication message to an edge computing device, to enable the edge computing device to perform message scheduling on each received vehicle communication message,
the receiving module 1010 being further configured to receive the scheduled vehicle communication message transmitted by the edge computing device; and
the transmission module 1020 being further configured to forward the scheduled vehicle communication message to another vehicle-mounted terminal other than a transmitter vehicle-mounted terminal, the transmitter vehicle-mounted terminal being a vehicle-mounted terminal transmitting the vehicle communication message.

In some embodiments, the transmission module 1020 is configured to:
forward the vehicle communication message to the edge computing device when message scheduling on the vehicle platoon is not supported;
the apparatus further includes:
a scheduling module, configured to perform message scheduling on each received vehicle communication message when message scheduling on the vehicle platoon is supported; and
the transmission module 1020 is configured to forward the scheduled vehicle communication message to the another vehicle-mounted terminal other than the transmitter vehicle-mounted terminal.

In some embodiments, the receiving module 1010 is further configured to obtain a message scheduling policy transmitted by the edge computing device, the message scheduling policy indicating a message scheduling manner of the vehicle communication message in the vehicle platoon; and

a determining module is configured to: determine that message scheduling on the vehicle platoon is supported, when the message scheduling policy corresponding to the vehicle platoon is stored; or determine that message scheduling on the vehicle platoon is not supported, when the message scheduling policy corresponding to the vehicle platoon is not stored.

FIG. 11 is a schematic structural diagram of a computer device according to an exemplary embodiment of this application. The computer device may implement the vehicle-mounted terminal, the core network user plane device, or the edge computing device in the foregoing embodiments.

The computer device 1100 includes a central processing unit (CPU) 1101, a system memory 1104 including a random access memory 1102 and a read-only memory 1103, and a system bus 1105 connecting the system memory 1104 and the central processing unit 1101. The computer device 1100 further includes a basic input/output (I/O) system 1106 assisting in information transmission between components in the computer, and a mass storage device 1107 configured to store an operating system 1113, an application program 1114, and another program module 1115.

The basic input/output system 1106 includes a display 1108 configured to display information and an input device 1109 like a mouse or a keyboard that is configured to input information by a user. The display 1108 and the input device 1109 are both connected to the central processing unit 1101 through an input/output controller 1110 connected to the system bus 1105. The basic input/output system 1106 may further include the input/output controller 1110 to be configured to receive and process inputs from a plurality of other devices such as a keyboard, a mouse, and an electronic stylus. Similarly, the input/output controller 1110 further provides an output to a display screen, a printer, or another type of output device.

The mass storage device 1107 is connected to the central processing unit 1101 through a mass storage controller (not shown) connected to the system bus 1105. The mass storage device 1107 and a computer-readable medium associated therewith provide non-volatile storage for the computer device 1100. In other words, the mass storage device 1107 may include the computer-readable medium (not shown) like a hard disk or a drive.

Without loss of generality, the computer-readable medium may include a computer storage medium and a communication medium. The computer storage medium includes volatile and non-volatile media, and removable and non-removable media implemented by using any method or technology configured for storing information such as computer-readable instructions, data structures, program modules, or other data. The computer storage medium includes a random access memory (RAM), a read-only memory (ROM), a flash memory or another solid-state storage technology, a compact disc read-only memory (CD-ROM), a digital versatile disc (DVD) or another optical memory, a magnetic cassette, a magnetic tape, a magnetic disk memory, or another magnetic storage device. A person skilled in the art may learn that the computer storage medium is not limited to the foregoing several types. The system memory 1104 and the mass storage device 1107 may be collectively referred to as a memory.

The memory stores one or more programs. The one or more programs are configured to be executed by one or more central processing units 1101. The one or more programs include instructions for implementing the foregoing method. The central processing unit 1101 executes the one or more programs to implement the method provided in the foregoing method embodiments.

According to embodiments of this application, the computer device 1100 may further be connected, through a network like an internet, to a remote computer on the network for running. In other words, the computer device 1100 may be connected to a network 1112 through a network interface unit 1111 connected to the system bus 1105, or may be connected to another type of network or a remote computer system (not shown) through the network interface unit 1111.

In addition, an embodiment of this application further provides a storage medium, configured to store a computer program. The computer program is configured for performing the method provided in the foregoing embodiments.

An embodiment of this application further provides a computer program product including a computer program, the computer program product, when run on a computer, enabling the computer to perform the method provided in the foregoing embodiments.

A person of ordinary skill in the art may understand that all or some of the steps of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely optional embodiments of this application, but are not intended to limit this application. Any modification, equivalent replacement, or improvement made within the spirit and principle of this application shall fall within the scope of this application.

What is claimed is:

1. A message transmission method, performed by an edge computing device, comprising:
receiving vehicle communication messages transmitted by a core network user plane device in a core network, each of the vehicle communication messages being transmitted through a communication network to the core network by a vehicle-mounted terminal mounted at one of platooning vehicles in one or more vehicle platoons;
performing message scheduling on the vehicle communication messages; and
transmitting the vehicle communication messages subjected to the message scheduling to the core network user plane device, to enable the core network user plane device to forward the vehicle communication messages through the communication network, each of the vehicle communication messages being forwarded to one or more vehicle-mounted terminals other than the vehicle-mounted terminal that transmits the vehicle communication message.

2. The method according to claim 1, wherein:
performing the message scheduling includes, for one vehicle communication message:
determining a message priority of the one vehicle communication message; and
inserting the one vehicle communication message into a message queue based on the message priority, the message queue storing one or more vehicle communication messages that have not been forwarded; and
transmitting the vehicle communication messages to the core network user plane device includes:
transmitting the vehicle communication message at a head of the message queue to the core network user plane device, the vehicle communication message at the head of the message queue having a highest message priority in the message queue;
the method further comprising:
removing the vehicle communication message that has been forwarded from the head of the message queue.

3. The method according to claim 2, wherein determining the message priority of the one vehicle communication message includes:
determining the message priority based on a priority identifier included in the one vehicle communication message, the priority identifier being determined and added to the one vehicle communication message by the vehicle-mounted terminal transmitting the one vehicle communication message; or
obtaining a message parameter from the one vehicle communication message, and determining the message priority of the one vehicle communication message based on the message parameter.

4. The method according to claim 3, wherein:
the message parameter includes a transmitter identifier and an event type; and
determining the message priority of the one vehicle communication message based on the message parameter includes:
determining that the one vehicle communication message has a first message priority, in response to the transmitter identifier representing that the one vehicle communication message is transmitted by a head platooning vehicle in one of the one or more vehicle platoons and the event type is a special event;
determining that the one vehicle communication message has a second message priority, in response to the transmitter identifier representing that the one vehicle communication message is transmitted by a head platooning vehicle in one of the one or more vehicle platoons and the event type is a regular event; or
determining that the one vehicle communication message has a third message priority, in response to the transmitter identifier representing that the one vehicle communication message is transmitted by a following platooning vehicle in one of the one or more vehicle platoons, the following platooning vehicle being a vehicle other than a head platooning vehicle in one of the one or more vehicle platoons; and
the first message priority is higher than the second message priority, and the second message priority is higher than the third message priority.

5. The method according to claim 4, wherein determining that the one vehicle communication message has the third message priority in response to the transmitter identifier represents that the one vehicle communication message is transmitted by a following platooning vehicle includes:
determining a platooning position of the following platooning vehicle in the one of the one or more vehicle platoons in response to the transmitter identifier represents that the one vehicle communication message is transmitted by the following platooning vehicle; and
determining a message sub-priority of the one vehicle communication message from the third message priority based on the platooning position, the message sub-priority being higher for the platooning position closer to the head platooning vehicle.

6. The method according to claim 1, wherein transmitting the vehicle communication messages to the core network user plane device includes, for one vehicle communication message:
obtaining a platoon identifier from the one vehicle communication message, the platoon identifier representing one vehicle platoon to which the platooning vehicle carrying a transmitter vehicle-mounted terminal that transmitted the one vehicle communication message belongs;
determining one or more receiver addresses based on a transmitter address of the transmitter vehicle-mounted terminal and terminal addresses of the vehicle-mounted terminals corresponding to the platoon identifier; and
transmitting the one vehicle communication message including the one or more receiver addresses to the core network user plane device.

7. The method according to claim 1, further comprising:
receiving a vehicle registration message transmitted by the core network user plane device, the vehicle registration message being transmitted by one vehicle-mounted terminal to the core network through the communication network, and the vehicle registration message including a terminal address of the one vehicle-mounted terminal and a platoon identifier representing one vehicle platoon to which one platooning vehicle carrying the one vehicle-mounted terminal belongs; and
associatively storing the platoon identifier and the terminal address.

8. An edge computing device comprising:
a processor; and
a memory storing a computer program that, when executed by the processor, causes the edge computing device to perform the method according to claim 1.

9. A non-transitory computer-readable storage medium storing a computer program that, when executed by a processor, causes an edge computing device including the processor to perform the method according to claim 1.

10. A message transmission method, performed by a vehicle-mounted terminal mounted at a platooning vehicle in a vehicle platoon that includes a plurality of platooning vehicles, comprising:
generating a vehicle communication message; and
transmitting the vehicle communication message to a core network through a communication network, to enable a core network user plane device in the core network to transmit the vehicle communication message to an edge computing device, for the edge computing device to perform message scheduling on the vehicle communication message, and forward the vehicle communication message subjected to the message scheduling to another vehicle-mounted terminal in the vehicle platoon through the core network user plane device.

11. The method according to claim 10, wherein generating the vehicle communication message includes:
determining a message priority based on a message parameter, and generating the vehicle communication message including a priority identifier based on the message priority; or
generating the vehicle communication message including the message parameter configured for determining the message priority of the vehicle communication message.

12. The method according to claim 11, wherein:
the message parameter includes a transmitter identifier and an event type;
determining the message priority based on the message parameter includes:
determining that the vehicle communication message has a first message priority, in response to the transmitter identifier representing that the platooning vehicle is a head platooning vehicle in the vehicle platoon and the event type is a special event;
determining that the vehicle communication message has a second message priority, in response to the transmitter identifier representing that the platooning vehicle is a head platooning vehicle in the vehicle platoon and the event type is a regular event; or
determining that the vehicle communication message has a third message priority, in response to the transmitter identifier representing that the platooning vehicle is a following platooning vehicle in the vehicle platoon, the following platooning vehicle being a vehicle other than a head platooning vehicle in the vehicle platoon; and
the first message priority is higher than the second message priority, and the second message priority being higher than the third message priority.

13. The method according to claim 12, wherein determining that the vehicle communication message has the third message priority in response to the transmitter identifier representing that the platooning vehicle is a following platooning vehicle in the vehicle platoon includes:
determining a message sub-priority of the vehicle communication message from the third message priority based on a platooning position of the following platooning vehicle in the vehicle platoon in response to the transmitter identifier representing that the platooning vehicle terminal is the following platooning vehicle in the vehicle platoon, the message sub-priority being higher for the platooning position closer to the head platooning vehicle.

14. The method according to claim 10, further comprising:
generating a vehicle registration message including a platoon identifier and a terminal address, the platoon identifier representing the vehicle platoon to which the platooning vehicle belongs; and
transmitting the vehicle registration message to the core network through the communication network, to enable the core network user plane device to transmit the vehicle registration message to the edge computing device, for the edge computing device to associatively store the platoon identifier and the terminal address, and determine one or more receiver addresses based on a transmitter address of the vehicle-mounted terminal and terminal addresses of vehicle-mounted terminals corresponding to the platoon identifier when forwarding the vehicle communication message.

15. A vehicle-mounted terminal comprising:
a processor; and
a memory storing a computer program that, when executed by the processor, causes the vehicle-mounted terminal to perform the method according to claim 10.

16. A non-transitory computer-readable storage medium storing a computer program that, when executed by a processor, causes an edge computing device including the processor to perform the method according to claim 10.

17. A message transmission method, performed by a core network user plane device, comprising:
receiving, through a communication network, vehicle communication messages transmitted by vehicle-mounted terminals each mounted at one of platooning vehicles in a vehicle platoon;
forwarding the vehicle communication messages to an edge computing device, to enable the edge computing device to perform message scheduling on the vehicle communication messages;
receiving, from the edge computing device, the vehicle communication messages subjected to the message scheduling; and
forwarding the vehicle communication messages subjected to the message scheduling, including, for one vehicle communication message:
forwarding the one vehicle communication message to one of more of the vehicle-mounted terminals other than a transmitter vehicle-mounted terminal that transmitted the one vehicle communication message.

18. The method according to claim 17,
wherein forwarding the vehicle communication messages to the edge computing device includes:
forwarding the vehicle communication messages to the edge computing device in response to message scheduling on the vehicle platoon not being supported;
the method further comprising:
performing message scheduling on the vehicle communication messages in response to message scheduling on the vehicle platoon being supported.

19. The method according to claim 18, further comprising:
obtaining a message scheduling policy transmitted by the edge computing device, the message scheduling policy indicating a message scheduling manner for the vehicle platoon; and
determining whether message scheduling on the vehicle platoon is supported, including:
determining that message scheduling on the vehicle platoon is supported, in response to the message scheduling policy corresponding to the vehicle platoon being stored; or
determining that message scheduling on the vehicle platoon is not supported, in response to the message scheduling policy corresponding to the vehicle platoon not being stored.

20. A core network user plane device comprising:
a processor; and
a memory storing a computer program that, when executed by the processor, causes the core network user plane device to perform the method according to claim 17.
